(19) United States
(12) Patent Application Publication
(10) Pub. No.: US 2017/0142972 A1
(43) Pub. Date: May 25, 2017

(54) ANTIMICROBIAL COMPOSITION INHIBITS BACTERIA AND FUNGI

(71) Applicant: Troy Corporation, Florham Park, NJ (US)

(72) Inventors: Richard S. Valpey, III, Rockaway, NJ (US); Rajinder Kaur Mudhar, Monroe, NJ (US)

(21) Appl. No.: 15/424,613

(22) Filed: Feb. 3, 2017

(51) Int. Cl. A01N 43/80; A01N 25/02; C09D 5/14; A01N 43/40; C09J 11/06

(52) U.S. Cl. CPC A01N 43/80; A01N 43/40; C09J 11/06; C09D 5/14; A01N 25/02

(57) ABSTRACT

An antimicrobial composition including an alkyl pyridinium or a salt of alkyl pyridinium and an isothiazolinone or a salt of an isothiazolinone is effective against bacterial and fungicidal growth and resulting degradation in paints, emulsions, adhesives, and joint compounds, among other things. The composition may be employed in an aqueous liquid medium. Carriers may be employed to deliver the antimicrobial mixtures in liquid or pellet form. The invention is also a method for inhibiting microbial growth which employs the antimicrobial composition.

In a preferred aspect, the invention is antimicrobial composition which includes cetyl pyiridinium choride and benzisothiazolinone salt, in a proportion that is synergistically effective against Pseudomonas aeruginosa, Escherichia coli, Enterobacter aerogenes, and Alcaligenes faecailis.

### BACKGROUND OF THE INVENTION

### Field of the Invention

The invention relates to surprisingly effective antimicrobial compositions for protecting paints, emulsions, adhesives, joint compounds, and other products against degradation associated with bacterial and fungicidal growth.

### Background of the Invention

Materials which can be degraded by microorganisms such as bacteria and fungi include, for example, paints, emulsions, adhesives, and joint compounds. The degradation may produce, among other things, discoloration, odors, changes in pH values, and/or changes in rheological properties. Protection against bacterial and fungal growth and related degradation may be required over a relatively long period of time, such as protection for material in storage.

Bacteria which can cause this degradation include Pseudomonas aeruginosa, Escherichia coli, Enterobacter aerogenes, and Alcaligenes faecalis. Degrading fungi are exemplified by Aspergillus niger and Penicillium sp.

Generally, a composition in a smaller amount that provides the same antimicrobial activity is a superior product, as compared to other antimicrobial compositions. Ideally, these superior compositions should protect against a wide variety of problem microorganisms and remain effective for an extended period of time, without adversely affecting the product to be protected, the health of people who make or use the product, or the environment.

Published patent application EP 2 807 925, which lists SymriseAG as applicant and Pesaro et al. as inventors, describes an antimicrobial mixture comprising (a) at least one first antimicrobial agent selected from the glyceryl ethers of formula (I) or (II) and (b) at least one second antimicrobial agent selected from a large group of preservatives, which group includes cetyl pyridinium chloride and benzisothiazolinone among other antimicrobial agents. The patent application does not teach a surprisingly effective antibacterial and antifungal composition which includes cetyl pyridinium chloride and benzisothiazolinone.

Chemical stability, toxicological profile, regulatory considerations, environmental concerns, physical properties or other characteristics may render a particular ingredient unsuitable for a particular use. Accordingly, there is a need to constantly develop new antimicrobial compositions that offer broad spectrum protection for a variety of needs.

### SUMMARY OF THE INVENTION

The invention is an antimicrobial composition including alkyl pyridinium or a salt of alkyl pyridinium, isothiazolinone or a salt of isothiazolinone; and an aqueous liquid medium. The composition is effective against bacterial and fungicidal growth and associated degradation of paints, emulsions, adhesives, and joint compounds, among other things. Carriers may be employed to deliver the antimicrobial mixtures in liquid or pellet form. The invention is also a method for inhibiting microbial growth which employs the antimicrobial composition.

In a preferred aspect, the invention is an antimicrobial composition which includes a pyridinium component, an isothiazolinone component, and in aqueous liquid medium. The pyridinium component may include an alkyl pyridinium or the salt of an alkyl pyridinium, each of which preferably includes about eight to about twenty-two carbon atoms per molecule, more preferably about fourteen to twenty atoms per molecule.

The isothiazolinone component may include an isothiazolinone selected from the group consisting of methylisothiazolinone (hereinafter referred to as “MIT”), chloromethylisothiazolinone (hereinafter referred to as “CMIT”), benzisothiazolinone (hereinafter referred to as “BIT”), octylisothiazolinone (hereinafter referred to as “OIT”), dichloromethyloctylisothiazolinone (hereinafter referred to as “DCOIT”), and mixtures thereof. MIT, CMIT BIT, and mixtures thereof are especially preferred as the isothiazolinone component.

Preferably, the pyridinium component and the isothiazolinone component are present in the antimicrobial composition in a proportion within the range of about 9:1 to about 1:9. More preferably, the pyridinium component and the isothiazolinone component are present in a proportion that is synergistically effective against fungi known as Aspergillus niger or Penicillium Sp. Most preferably, the pyridinium component and the isothiazolinone component are present in a proportion that is synergistically effective against bacteria known as Pseudomonas aeruginosa, Escherichia coli, Enterobacter aerogenes, and Alcaligenes faecailis.

In another preferred aspect, the invention is an anti-microbial composition which includes cetyl pyridinium chloride (hereinafter referred to as “CPC”), BIT, and aqueous liquid medium. In this aspect, CPC and BIT are preferably present in a proportion synergistically effective against Aspergillus niger and against Penicillium sp.

In the yet another, preferred aspect, the invention is a method for making a wet state mixture that is resistant to fungal and bacterial infestation. The method includes combining an antimicrobial composition which includes alkyl pyridinium or a salt thereof and an isothiazolinone or a salt thereof in a proportion synergistically effective against Aspergillus niger and Penicillium sp., with an aqueous liquid medium to produce a coating precursor. The method also includes exposing the coating precursor to an oxygen-containing gas to form a wet state mixture that is resistant to fungal and bacterial infestation.

In the yet another preferred aspect, the invention is a method for making an emulsion that is resistant to fungal and bacterial infestation. In the method, an antifungal composition containing alkyl pyridinium or a salt thereof and an isothiazolinone or a salt thereof in a proportion synergistically effective against Aspergillus niger and Penicillium sp are combined with an aqueous liquid medium to produce an emulsion that is resistant to fungal and bacterial infestation. Preferably, the antifungal composition is adsorbed, absorbed, or dissolved in a resin carrier, and the resin carrier is subsequently introduced into the aqueous liquid medium to produce the emulsion.

These and other aspects of the invention are described below.

### DETAILED DESCRIPTION OF PREFERRED EMBODIMENTS

The antimicrobial composition of the invention is useful as a preservative for paints, coatings, exterior insulation and finish systems, stucco, wood preservative coatings, wood-plastic composites, adhesives, mineral slurries, dispersions, emulsions, aqueous materials, sealants, textiles, and the like, in a broad range from about 0.004 mass % to 10 mass % active concentration. The final formulation can be prepared from more highly concentrated compositions of the active ingredients by appropriate dilution. A preferred range for combined active ingredients in the final formulation range is about 0.01 mass % to about 4 mass %, more preferably about 0.1 mass % to about 2 mass %. The fmal formulation can protect aqueous substrates against microbial growth for extended periods of time

Compositions of the invention will generally be formulated by mixing or dispersing the active ingredients in selected proportions with a liquid or solid vehicle for dissolving or suspending the active components, provided that the liquid vehicle does not materially affect the antimicrobial efficacy of the compositions. The vehicle may contain a diluent, an emulsifier, an anti-foam agent, and a wetting-agent; provided that the diluent, the emulsifier, an anti-foam agent, and the wetting-agent do not materially affect the three-component antimicrobial efficacy of the compositions. The compositions of the invention may be provided as wettable powders; liquid mixtures such as dispersions, emulsions, microemulsions; or any other suitable form, provided that any additional material which is be present in the composition does not materially affect the antimicrobial efficacy of the compositions.

When preparing formulations of the invention for specific applications, the composition may include conventional adjuvants such as organic binding agents, additional fungicides, auxiliary solvents, processing additives, fixatives, plasticizers, UV-stabilizers or stability enhancers, water soluble or water insoluble dyes, color pigments, siccatives, corrosion inhibitors, anti-settling agents, anti-skinning agents and the like, provided that the adjuvants do not materially affect the antimicrobial efficacy of the composition.

Treating substrates with a composition of the invention can protect them from microbial attack. The protective treatment may involve mixing the composition with the substrate, coating the substrate with the composition, or otherwise contacting the substrate with the composition. In a preferred aspect, the invention is a method for protecting a substrate from bacterial and fungal infestation. The method includes treating the substrate with an antimicrobially effective amount of a composition that includes an alkyl pyridinium or the salt of an alkyl pyridinium and an isothiazolinone or the salt of an isothiazolinone.

It is especially preferred that the antimicrobial composition of the invention does not include as a component any glycerylether that contains a hydrocarbyl radical selected from the group consisting of benzyl, methylbenzyl, phenylethyl, and phenylpropyl radicals, and alkyl radicals having 2 to 12 carbon atoms.

The following examples are presented to explain the invention, and are not intended to limit the scope of invention in any way. Unless otherwise indicated, all references to parts and percentages are based on mass.

### EXAMPLES

### Example 1

### Challenge Method for Quantifying Antibacterial Effectiveness

In order to quantify the relative antibacterial effectiveness of an antimicrobial composition, samples are prepared by adding various amounts of the antimicrobial composition to identical volumes of a sterile test material. For this method, a test material that exhibits no observable growth after five days of incubation on Trypticase Glucose Extract Agar at 30 degrees C. is considered sterile. Each of the samples is subjected to a two-part challenge procedure and the sample that provides acceptable anti-bacterial protection with the lowest concentration of the antimicrobial composition is identified.

Each part of the anti-bacterial challenge consists of a 7-day test cycle. The parts are performed consecutively over 14 test days. Acceptable anti-bacterial protection is achieved when the test product exhibits complete sterility by the end of the second seven-day cycle. Even if a sample exhibits bacterial growth earlier in the challenge procedure, it is the final reading at the end of the 14 test days that determines whether anti-bacterial protection is acceptable.

Challenge testing is accomplished using a mixed bacterial inoculum as the contamination event. These bacteria are Pseudomonas aeruginosa (ATCC #10145), Escherichia coli (ATCC #11229), Enterobacter aerogenes (ATCC #13048), and Alcaligenes faecalis (ATCC #25094). To make the test inoculum, each type of bacteria is grown separately in nutrient broth. Just before use in the challenge test, equal volumes of the four types of bacteria are blended together to make a mixed inoculum.

After incubation, both control blanks and samples containing preservative are inoculated with the mixed inoculum. The mixed inoculum is stirred evenly through the test sample, incubated for one day at room temperature, and then streaked on plates. The test sample streaked again after an incubation period of two days, and again after an incubation period of seven days.

Performance ratings of 0, 1, 2, 3 or 4 for each test sample are determined by visual inspection according to the definitions set forth below in Table 1.

TABLE 1

| Performance Rating | Definition |
|---|---|
| 0 | No bacterial growth |
| 1 | Trace of bacterial growth |
| 2 | Light bacterial growth |
| 3 | Moderate bacterial growth |
| 4 | Heavy bacterial growth |

### Example 2

### Challenge Method for Quantifying Antifungal Effectiveness

In order to quantify the relative antifungal effectiveness of an antimicrobial composition, samples are prepared by adding various amounts of the antimicrobial composition to identical volumes of a sterile test material. For this method, a test material that exhibits no observable growth after five days of incubation on Malt Agar at 30 degrees C. is considered sterile. Each of the samples s subjected to a two-part challenge procedure and the sample that provides acceptable anti-fungal protection with the lowest concentration is identified.

Each part of the two-part challenge procedure consists of a seven-day test cycle. The parts are performed consecutively over 14 test days. Acceptable anti-fungal protection is defined as complete sterility at the end of the 14 test days. Even if a sample exhibits fungal growth earlier in the challenge procedure, it is the final reading at the end of the second seven-day test cycle that determines whether anti-fungal protection is acceptable.

At the start of each seven-day cycle, a mixed fungal inoculum is introduced into the sample. The inoculum is a spore suspension prepared from week-old Malt Agar slants, and includes Aspergillus niger and Penicillium sp. These two fungi are believed to be representative of fungi that cause biological spoilage of paints, emulsions, adhesives, joint compounds, and other products.

At the end of each seven-day cycle, the sample is streaked upon Malt Agar by using sterile cotton swabs to transfer a quantity of the test sample to the surface of a culture medium petri plate. Duplicate petri plates are made for the sample.

Performance ratings of 0, 1, 2, 3 or 4 for the sample are determined visually according to the definitions set forth below in Table 2.

TABLE 2

| Performance Rating | Definition |
|---|---|
| 0 | No fungal growth |
| 1 | Trace of fungal growth |
| 2 | Light fungal growth |
| 3 | Moderate fungal growth |
| 4 | Heavy fungal growth |

If the streaked culture medium petri plates at the end of the second seven-day cycle indicate no growth, the anti-fungal protection for the sample is considered acceptable. If the streaked culture medium petri plates at the end of the second-day cycle indicate any growth whatsoever, the anti-fungal protection for the sample is considered unacceptable.

### Example 3

### Bacterial and Fungal Protection of Emulsion

The Antibacterial Challenge Method described above in Example 1 and the Antifungal Challenge Method described above in Example 2 are performed on an emulsion samples with no preservatives and on emulsion samples including CPC and BIT. Challenge results are reported in Table 3, below.

TABLE 3

| | | | | | | | Fungal | | |
|---|---|---|---|---|---|---|---|---|---|
| | | | | | | | Chal- | | |
| | | | | | | | lenge | | |
| | | | | | | | Perfor- | | |
| | | | | | | | mance | | |
| | Bacterial Challenge | | | | | | Rating+ | | |
| | Performance Rating* | | | | | | On Test | | |
| | On Test Day | | | | | | Day | | |
| | Test Day | | | | | | | | |
| | 1 | 2 | 7 | 8 | 9 | 14 | 7 | 14 | Observations |
| Emulsion | 4 | 4 | 4 | 4 | 4 | 4 | 4 | 4 | Not Protected |
| Without | | | | | | | | | Against Bacterial |
| Preservatives | | | | | | | | | or Fungal |
| | | | | | | | | | Growth |
| | | | | | | | | | On Test Day 14 |
| Emulsion with | 1 | 0 | 0 | 0 | 0 | 0 | 0 | 0 | Protected |
| 0.008% BIT | | | | | | | | | Against Bacterial |
| and | | | | | | | | | or Fungal |
| 0.04% CPC | | | | | | | | | Growth |
| | | | | | | | | | On Test Day 14 |

Legend
*See Table 1 for Definition of Bacterial Challenge Performance Rating
+See Table 2 for Definition of Fungal Challenge Performance Rating

Inspection of Table 3 indicates that an emulsion containing 0.008% BIT and 0.04% CPC can exhibit significant resistance to bacterial and fungal growth after two weeks of exposure to contamination.

### Example 4

### Bacterial Protection of Adhesive

The Antibacterial Challenge Method described above in Example 1 is performed on adhesive samples with no preservatives and on adhesive samples including CPC and BIT. Challenge results are reported in Table 4, below.

TABLE 4

| | Bacterial Challenge | | | | | | |
|---|---|---|---|---|---|---|---|
| | Performance Rating* | | | | | | |
| | On Test Day | | | | | | |
| | Test Day | | | | | | |
| | 1 | 2 | 7 | 8 | 9 | 14 | Observations |
| Adhesive | 4 | 4 | 4 | 4 | 4 | 4 | Not Protected |
| Without | | | | | | | Against |
| Preservatives | | | | | | | Bacterial |
| | | | | | | | Growth |
| | | | | | | | On Test Day 14 |
| Adhesive | 4 | 3 | 2 | 4 | 3 | 3 | Not Protected |
| with | | | | | | | Against |
| 0.0066% BIT | | | | | | | Bacterial |
| | | | | | | | Growth |
| | | | | | | | On Test Day 14 |
| Adhesive | 3 | 3 | 0 | 4 | 2 | 0 | Protected |
| with | | | | | | | Against |
| 0.013% BIT | | | | | | | Bacterial |
| | | | | | | | Growth |
| | | | | | | | On Test Day 14 |
| Adhesive | 1 | 0 | 0 | 3 | 4 | 4 | Not Protected |
| with | | | | | | | Against |
| 0.5% CPC | | | | | | | Bacterial |
| | | | | | | | Growth |
| | | | | | | | On Test Day 14 |
| Adhesive | 3 | 1 | 0 | 3 | 1 | 0 | Protected |
| with | | | | | | | Against |
| 0.01% CPC | | | | | | | Bacterial |
| and 0.0005% BIT | | | | | | | Growth |
| | | | | | | | On Test Day 14 |
| Adhesive | 1 | 0 | 0 | 0 | 0 | 0 | Protected |
| with | | | | | | | Against |
| 0.01% CPC | | | | | | | Bacterial |
| and 0.001% BIT | | | | | | | Growth |
| | | | | | | | On Test Day 14 |

Legend
*See Table 1 for Definition of Bacterial Challenge Performance Rating

The data in Table 4 demonstrates that the adhesive with 0.01% CPC and 0.001 BIT and the adhesive with 0.01% CPC and 0.0005 BIT are both protected against bacterial growth after two weeks of exposure to contamination.

In addition, the data in Table 4 is evidence that CPC and BIT act synergistically to protect the adhesive against bacterial growth. Inspection of Table 4 reveals that at least about 0.013% BIT alone, and more than 0.5% CPC alone are required to provide the required protection against antibacterial growth on Test Day 14; and that the adhesive with 0.01% CPC and 0.0005% BIT and the adhesive with 0.01% CPC and 0.001% BIT are both protected on Test Day 14 with much less than 0.5% CPC and much less than 0.013% BIT. Based on this data, the combination of CPC and BIT is surprisingly effective against antibacterial growth, as compared to CPC alone or to BIT alone.

### Example 5

### Bacterial Protection of Paint

The Antibacterial Challenge Method described above in Example 1 is performed on adhesive samples with no preservatives and or adhesive samples including an aqueous CPC and BIT composition. Challenge results are reported in Table 5, below.

TABLE 5

| | Bacterial | | | | | | |
|---|---|---|---|---|---|---|---|
| | Challenge | | | | | | |
| | Performance | | | | | | |
| | Rating* on | | | | | | |
| | Test Day | | | | | | |
| | Test Day | | | | | | |
| | 1 | 2 | 7 | 8 | 9 | 14 | Observations |
| Paint | 4 | 4 | 2 | 4 | 4 | 4 | Not Protected |
| Without | | | | | | | Against |
| Preservatives | | | | | | | Bacteria |
| | | | | | | | On Test Day 14 |
| Paint with | 3 | 3 | 2 | 3 | 3 | 2 | Not Protected |
| 0.02% BIT | | | | | | | Against |
| | | | | | | | Bacteria |
| | | | | | | | On Test Day 14 |
| Paint with | 3 | 1 | 0 | 3 | 2 | 0 | Protected |
| 0.04% BIT | | | | | | | Against |
| | | | | | | | Bacteria |
| | | | | | | | On Test Day 14 |
| Paint with | 4 | 4 | 2 | 4 | 4 | 4 | Not Protected |
| 0.5% CPC | | | | | | | Against |
| | | | | | | | Bacteria |
| | | | | | | | On Test Day 14 |
| Paint with | 1 | 0 | 0 | 2 | 1 | 0 | Protected |
| 0.01% CPC | | | | | | | Against |
| and | | | | | | | Bacteria |
| 0.002 BIT | | | | | | | On Test Day 14 |
| Paint with | 0 | 0 | 0 | 0 | 0 | 0 | Protected |
| 0.02% CPC | | | | | | | Against |
| and | | | | | | | Bacteria |
| 0.004 BIT | | | | | | | On Test Day 14 |

Legend
*See Table 1 for Definition of Bacterial Challenge Performance Rating

The data in Table 5 demonstrates that the paint with 0.01% CPC and 0.002 BIT and the paint with 0.02% CPC and 0.004 BIT are both protected against bacterial growth after two weeks of exposure to contamination.

In addition, the data in Table 5 is evidence that CPC and BIT act synergistically to protect the paint against bacterial growth. Inspection of Table 5 reveals that at least about 0.004% BIT alone, and more than 0.5% CPC alone are required to provide the required protection against antibacterial growth on Test Day 14; and that the paint with 0.01% CPC and 0.002 BIT and the paint with 0.02% CPC and 0.004 BIT are both protected on Test Day 14 with much less than 0.5% CPC and much less than 0.04% BIT. Based on this data, the combination of CPC and BIT is surprisingly effective against antibacterial growth, as compared to CPC alone or to BIT alone.

### Example 6

### Fungal Protection of Joint Compound

The Antifungal Challenge Method described above in Example 2 is performed on joint compound samples with no preservatives and on joint compound samples including an aqueous CPC and BIT composition. Challenge results are reported in Table 6, below.

TABLE 6

Fungal Challenge
Performance
Rating+ on Test
Day

| Test Day | 7 | 14 | Observations |
|---|---|---|---|
| Joint Compound | 3 | 4 | Not protected |
| without | | | against Fungus |
| Preservatives | | | On Test Day 14 |
| Joint Compound | 0 | 0 | Protected against |
| with | | | Fungus |
| 0.2% CPC and | | | On Test Day 14 |
| 0.01% BIT | | | |

Legend
+See Table 2 for Definition of Fungal Challenge Performance Rating

The data in Table 6 indicates that an antimicrobial composition including CPC and BIT inhibits the growth of fungus in joint compound.

While the invention has been described in terms of specific embodiments and examples, its scope is limited only by the scope of the appended claims.

We claim as our invention:

1. An antimicrobial composition, comprising:
an alkyl pyridinium or a salt thereof;
an isothiazolinone or a salt thereof; and
an aqueous liquid medium.

2. The composition of claim 1, in which the alkyl pyridinium or the salt thereof includes about eight to about twenty-two carbon atoms per molecule.

3. The composition of claim 2, in which the alkyl pyridinium or the salt thereof includes about fourteen to about twenty atoms per molecule.

4. The composition of claim 1, in which the isothiazolinone is selected from the group consisting of MIT, CMIT, BIT, OIT, DCOIT, and mixtures thereof.

5. The composition of claim 4, in which the isothiazolinone is selected from the group consisting of MIT, CMIT, BIT, and mixtures thereof.

6. The composition of claim 1, in which the alkyl pyridinium or the salt thereof and the isothiazolinone or the salt thereof are present in a proportion within the range of about 9:1 to about 1:9.

7. The composition of claim 1, which is effective against Aspergillus niger or Penicillium sp.

8. The composition of claim 1, in which the alkyl pyridinium or the salt thereof and the isothiazolinone or the salt thereof synergistically effective against Pseudomonas aeruginosa, Escherichia coli, Enterobacter aerogenes, or Alcaligenes faecailis.
